(19) United States
(12) Patent Application Publication
(10) Pub. No.: US 2006/0196299 A1
(43) Pub. Date: Sep. 7, 2006

(54) Seven Axis End Effector Articulating Mechanism

(76) Inventors: John Taboada, San Antonio, TX (US); John Martin Taboada, San Antonio, TX (US)

Correspondence Address: JOHN MARTIN TABOADA, 1923 N. NEW BRAUNFELS, SAN ANTONIO, TX, 78208, US

(21) Appl. No.: 10/905,926

(22) Filed: Jan. 27, 2005

(51) Int. Cl. B25J 18/00

(52) U.S. Cl. 74/490.01

(57) ABSTRACT

A computer or remote controlled end effector articulating mechanism provides accurate and independent seven axis actuation of an operator such as a tool, platform, sensor, biological specimen or other object such as a workpiece. The object(s) or operator(s) may be mounted on end effector element 7 which is linearly translated 9 along axis 5 and rotated 2 about the same axis by conventional computer or remotely controlled linear actuator and rotator mounted on or within element 11. Element 11 is in turn linked to a further mechanism comprised of pivot axes 13, 15, 21, 23, 25, 45 and 47 connected to linkage elements 17, 19, 22 and 43. These linkages are connected to a rotatable axle 29. Orthogonal rotary motion is imparted to these linkages by mechanism 30 comprised of 27, 29, 31, 33, 35, 37, 39, 41, 43, 51, 53, 55, 57, and 59. The orthogonal rotary motion imparted by mechanism 30 actuates 11 hence element 7 to move about orthogonal spherical coordinate paths 4 and 6 centered at point 1, the intersection of axis 5 and axis 3. Linear actuation is further imparted on the intercept point 1 by orthogonally arranged serially connected linear translators 61, 63, and 65, a fixed to stationary fixture 67. Thus, there is totally independent x, y, z translation of a three-axis spherical coordinate articulated mechanism with an added twist about the spherical coordinate radius vector.

### BACKGROUND OF THE INVENTION

This invention is directed to automated or remote-controlled mechanisms for generating precise seven-degrees-of-freedom position and motion trajectories for tool tips, end effectors, biological specimens, platforms, workpieces, and the like.

### DESCRIPTION OF PRIOR ART

The scope of this invention includes applications as diverse as medical procedures such as arthroscopic surgery or ophthalmic exams, biological specimen articulation, sensor or specimen articulation, as in x-ray diffractometry, microscopy, manufacturing assembly, parts machining, and motion simulation. Most mechanisms for six or more axis of articulation of an end effector are based on analogous simulation of the human arm with its links (bones) and joints. These structural analog features allow the hand which is an analog of the end effector to be moved and positioned with six or more degrees of freedom with respect to an otherwise stationary body. Such “elbowed” mechanisms known as robot arms in the art, however, lack desirable stiffness and require highly complex or computer controlled actuation of its driving motors to achieve even simple motion, such as arcuate motion. The analysis of the position and motion of the links of robot arms which are serially distributed is complicated when the analysis work backwards, i.e., from the “hand” to the fixed stationary body. The set optimum joint angles is sometimes an infinite set.

“Parallel” link mechanisms can provide improved motion analysis computations for computer control over that of the serial link robot arm. This approach has led to a number of multi-non-geometrically parallel link mechanisms. Prior art examples include U.S. Pat. No. 3,288,421 to Peterson (1966) which describes a six-legged “parallel” mechanism for moving a platform with six degrees of freedom. A further example is U.S. Pat. No. 3,295,224 to Cappel (1967), which is also a six legged “parallel” mechanism which works as a motion simulator such as the six degrees of freedom of helicopter flight. Still a further example of a multi-“parallel” link mechanism is U.S. Pat. No. 5,354,158 to Sheldon, et. al., (1994), which also describes a platform controlled by six variable length legs. A tendon link mechanism improvement upon the six-legged platform design is disclosed by U.S. Pat. No. 6,840,127 to Moran (2005).

Characteristic of the prior art is that the position and motion of the end effector is confounded by the non-orthogonal nature of the linkage motion, that is, most if not all motion (e.g., circular or orbital) of the end-effector requires the actuation of all six actuators in each leg as in U.S. Pat. Nos. 3,280,421, 3,295,224, and 5,354,158 or tendon as in U.S. Pat. No. 6,840,127. This complex actuation process requires a computer program which can run slower because of the parallel actuations that are needed. The motion/position can be difficult to compute because of the non orthogonal geometry and in determined nature of the problem. Further compounding the problem is that the degree of uncertainty of each leg or tendon is in multiple indeterminate directions, creating an extremely complex effect.

### BRIEF SUMMARY OF THE INVENTION

In accordance with the present invention, a seven axis end effector articulating mechanism is remotely or computer-controlled to produce accurate and tractable seven degrees of freedom motion and positioning of an end effector fixture element. Tools, platforms, workpieces, biological specimens, surgical instruments, mechanical grippers, radiation detectors, and the like may be mounted on the end effector fixture element to perform useful work.

### OBJECTS AND ADVANTAGES

To provide an improved six-degree of freedom motion articulating end effector positioner mechanism with an added degree of tractable motion.

To provide a seven-degree of freedom motion end effector articulating mechanism with totally independent, accurate, tractable, orthogonal motion actuation thereby drastically simplifying the control and speed of the actuators to achieve a given geometric position or trajectory.

To provide a seven-degree of freedom motion end effector articulating mechanism with economical robust highly accurate feedback.

To provide a seven-degree of freedom motion end effector articulating mechanism capable of real-time computer control with a human and/or computer interface.

Still further objectives and advantages will become apparent from a consideration of the ensuing description and drawing.

### BRIEF DESCRIPTION OF THE DRAWING

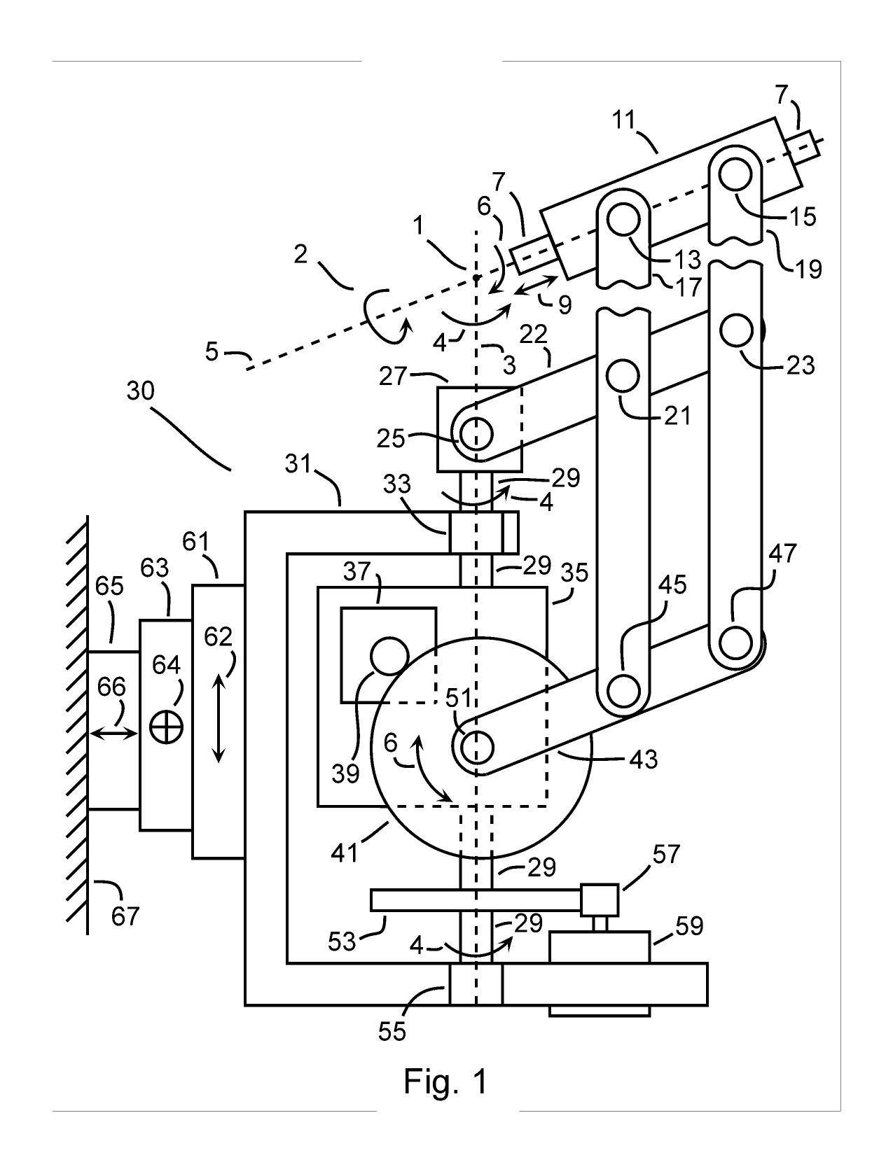

Supporting, fastening and aligning members as well as connecting power, sensors, and control wires are omitted to promote the clarity. FIG. 1 is a planar projection view of the preferred embodiment of the seven-axis end effector articulating mechanism.

### DESCRIPTION OF THE INVENTION

The preferred embodiment of the present invention is illustrated in FIG. 1. A coordinate point in three-dimensional space is indicated by 1. The present invention addresses the spherical coordinate articulation 4 and 6 about point 1 of an end effector attachment element 7. The present invention further addresses the to-and-fro motion 9 of element 7 and the rotary motion 2 of the same element 7. The linear motion of element 7 is directed to point 1 and its rotary motion is along axis 5 which passes through point 1. The linear and rotary motion of attachment element 7 is produced by linear and rotary actuators (not shown in FIG. 1 but well known in the art) contained in holder element 11. The invention also addresses the Cartesian coordinate movement in 3-D space of point 1.

Further articulated motion is imparted to end-effector attachment element 7 by geometrically parallel linkages 17 and 19, shown truncated by breaks in FIG. 1. Linkages 17 and 19 are connected to the end effector holder element 11 by pivot axis 13 and 15, respectively and to a third linkage 22 by pivot axis 21 and 23, respectively, and further connected to linkage 43 by pivot axis 45 and 47, respectively. Linkages 22 and 43 are arranged parallel to axis 5, which is collinear with a vector drawn between pivot axis 13 and 15. Linkage 22 is connected to a mounting block 27 having pivot axis 25 passing perpendicular through axis 3. Axis 3 pertains to a rigid rod 29 to which block 27 is rigidly attached. Rod 29 passes through a rotary bearing 33 in frame 31 then through a rigid fixture plate 35, to which it is rigidly attached. Rod 29 also passes through the center and rigidly attach to gear 53, shown side-on. The distal end of rod 29 rotates freely in bearing 55 in frame 31.

Linkages 43 attached to linkages 17 and 13 by pivot axis 45 and 47 respectively is rigidly attached to gear 41 which pivots at pivot axis 51 which passes perpendicular through axis 3. On account of the parallel linkages (17, 19, 22, and 43) and pivot axes (13, 15, 25, 45, and 47) rotation of gear 41 will impart to end-effector holder 11 rotational motion 6 about point 1 exactly equal to the rotary motion of gear 41 about pivot axis 51.

Actuation of gear 41 is accomplished by servo motor 37 (of the type well known in the art) which is attached to fixture plate 35. Servo motor 37 couples rotary motion through gear 39 coupled to gear 41. Servo motor 37 is remotely actuated or computer controlled as is well known in the art.

The entire assembly of end effector holder 11, linkages (17, 19, 22, and 23) linkage pivot axis block 27, fixture plate 35 with motor 37, gears 39 and 41, pivot axis 51, and rod 29 are axially rotated about axis 3 within bearings 33 and 55 by motion imparted to gear 53 by servo motor 59 through coupling gear 57. Servo motor 59 is controlled in a manner similar to 37. Axis 3 is aligned to pass through point 1. Rotary motions 4 and 6 are thus the azimuth and elevation motion axis of a spherical coordinate system centered at point 1. Radial motion 9 of the end-effector attachment element 7 is the radius vector motion of said spherical coordinate system.

The orthogonal x, y, z translation of the entire above described system is accomplished by a set of servo motor linear translation stages well known in the art, attached orthogonally and serially to the system at frame 31. Referring to FIG. 1, the translation stages are referenced by element 61 affixed to frame 31 imparting vertical position translation 62, element 63 affixed to element 61 imparting in-out translation 64 of the system and element 65 affixed to element 63 imparting left-right translation 66. Finally, translation stage 65 is attached to a rigid reference fixture 67. The x, y, z translations move the entire system with its pivot point 1 through 3-D space.

Very high accuracy and unconfounded position or motion feedback is obtained, by rotary shaft encoders located at pivot point 13 and or 15 and at bearing 33 or 55. Rotary shaft encoders are well known in the art. As the axes are all independent human or computer control of the end effector position and motion can be readily accomplished with extreme accuracy.

Although the above description contains many specific arrangements details, these should not be construed as limiting the scope of the invention but as merely providing an illustration of the presently preferred embodiment of this invention.

The scope of usage is very broad including but not limited to: machining parts, medical procedures, arthroscopic surgery, ophthalmic exams, biological specimen articulation, picking and placing, sensor or specimen articulation as in x-ray diffraction, microscopy, manufacturing assembly, and motion simulation.

What is claimed is:

1. A method for creating a seven axes end-effector articulating mechanism possessing spherical coordinate with additional rotary twist and Cartesian coordinate freedom of a localizable and known point comprising the steps of: containing a first movable linear and rotary motion actuated end-effector attachment element moving within or upon an elongated enclosure or platform; allowing rotary motion for said attachment element about an axis extending to the said point; allowing translational to and fro motion of said end-effector attachment element relative to said point; attaching to said enclosure or platform two or more parallel first linkages with first and second parallel pivot axis aligned perpendicular to the first rotary axis of the moveable end effector attachment element; extending and attaching said parallel linkages to two or more transverse parallel second linkages, such that their intercept points are joined by a third and fourth pivot axes parallel to the said first and second pivot axes; providing a rotatable axle with axis of rotation passing through said localizable and known point; extending and attaching one of said transverse linkages to said rotatable axle such that at least one said transverse linkage is attached to said rotatable axle by means of a block rigidly attached to said axle upon which a fifth pivot axis with axis aligned parallel to said first and second pivot axes affixes said linkage end; allowing one axis of rotation of the end of said transverse linkage perpendicular to the said axle axis; further extending and rigidly attaching one said transverse second linkage to a first gear such that the linkage vector passes through the center of said first gear; further affixing said second linkage to at least two parallel first linkages with a sixth and seventh pivot axes parallel to the said first and second pivot axes; attaching said first gear by means of an eighth pivot axis (having rotation axis parallel to the first and second said pivot axes) to a fixture plate rigidly attached to the said rotatable axle and where said eighth pivot axis is perpendicular to and projects through said axle axis; mounting the said axle to a rigid yoke frame by means of rotary bearings permitting the rotation of the said first and second linkages, hence the end-effector attachment element about the said axle axis; providing a second gear aligned perpendicular to said axle and affixed at its center to said axle; providing first and second actuating servo motors coupled to first and second gears by means of matching coupling gears; providing attachment of first servo motor to said rigid plate; providing attachment of second servo motor to said rigid yolk frame; actuating rotary motion of the first and second gears by means of remote or computer control; imparting spherical coordinate articulation about said localizable and known point of said end-effector attachment element; and imparting definable 3-D Cartesian coordinate positioning of said localizable and known point by means of 3 linear, orthogonally arranged, computer or remote controlled, actuations of linear motor actuated platforms serially attached to said yoke frame.

2. The method for creating a seven axis end effector articulating mechanism of claim 1 further including the steps of: combining a means for measuring linear motion said linear and rotary actuated end effector attachment element; combining a means for measuring rotary motion such as a shaft encode with said linear and rotary actuated end effector attachment element; combining means for measuring angular rotation with said first parallel pivot axis so as to provide highly accurate position feedback of the said enclosures or platform about a first spherical coordinate relative to said definable point; combining means for measuring angular rotation with said rotatable axle so as to provide highly accurate position feedback of the said enclosure or platform about a second a spherical coordinate relative to said definable point; combining means for measuring linear position with said three linear orthogonal, linear orthogonally computer or remote controlled actuation of linear motor actuated platform serially attached to the said yoke frame so as to provide highly accurate x, y, z coordinate position feedback of said definable point.

3. A seven axes end effector articulating mechanism comprising: a first linear and rotary motion actuated end effector attachment element moving within or upon an elongated enclosure or platform; a definable, localizable point in 3-D space located along the projected axis of said first linear and rotary motion actuated end effector attachment element; an elongated enclosure or platform in which or upon which said end effector attachment element moves; two or more geometrically first parallel linkages connected to said elongated enclosure or platform by means of first and second parallel pivot axes arranged perpendicular to and in line with said end effector attachment element linear movement axis; two or more second parallel linkages connected transversely to said first parallel linkages arranged parallel to the linear movement axis of said end effector attachment element, said connection being made by third and fourth pivot axis at each intersection point of said parallel linkages where said pivot axis are arranged such that their axis are parallel to said first and second pivot axis; a rotatable axle arranged so that its axis of rotation passes through said definable localizable point; a mounting block rigidly affixed to said rotatable axle; a fifth pivot axis attached and rotatable within said mounting block aligned perpendicular to the axis of said axle and parallel to said first and second parallel pivot axis; at least one of the said second parallel linkages connected to said fifth pivot axis such that the linkage is arranged parallel to the vector connecting the said first and second parallel pivot axis; a rigid frame yoke through which said rotatable axle is allowed to rotate within first and second rotational bearings; a planar plate rigidly attached to said rotatable axle and arranged parallel to said axle; a first planar gear connected to said planar plate by means of a sixth pivot axis passing through its center said pivot axis aligned perpendicular to said rotatable axle; at least one of the said second parallel linkages rigidly attached to said first gear such that the linkage is arranged parallel to the vector connecting the said first and second parallel pivot axis in such that the linkage center vector passes through the rotational axis of the pivot axis connecting the first gear to the said planar plate; a second planar gear rigidly attached at its center to said rotatable axle such that the axis of the second planar gear is concentric with the axis of the rotatable axle; a first servo motor attached to said planar plate and mechanically coupled to said first gear by mean of a first coupling gear so as to provide rotary motion of said first gear, imparting a first motion to said first and second parallel linkages; a second servo motor attached to said rigid frame yoke and mechanically coupled to said second gear by means of a second coupling gear so as to provide rotary motion of said rotatable axle, imparting a second motion to said first and second parallel linkages; and a series of first, second, and third linear actuator stages serially and orthogonally connected with proximal end connected to said rigid frame yoke and distal end connected to a stationary reference fixture.

4. The seven axes end effector articulating mechanism of claim 3 further including: a means for measuring linear position and movement of the movable linear and rotary motion actuated end effector attachment element relative to said elongated enclosure or platform; a means for measuring rotational position and movement of said attachment element relative to said enclosure or platform; a means for measuring rotational position and movement of said enclosure or platform relative to said geometrically parallel first linkages; a means for measuring the rotational position and movement of the said rotatable axle relative to the said frame yoke; a means for measuring the linear position and movement of each of the series of first, second, and third linear actuator stages serially and orthogonally connected, relative to the stationary reference fixture.

5. The seven axis end effector articulating mechanism of claim 4 further including: a human-operator or computer controller, whereby human or computer can direct the motion of said actuating mechanism.

6. The seven axis end effector articulating mechanism of claim 5 wherein said human operator interface is one or more joysticks or control arrays.

7. The seven axis end effector articulating mechanism of claim 5 wherein said human operator interface is a haptic wrist.

8. The seven axis end effector articulating mechanism of claim 5 wherein any one or more degrees of freedom can be excluded without disturbing of the function of the remaining mechanism.

9. The seven axis end effector articulating mechanism of claim 5 wherein said human operator interface is a head tracker.
